(19) United States
(12) Patent Application Publication
(10) Pub. No.: US 2007/0091188 A1
(43) Pub. Date: Apr. 26, 2007

(54) Adaptive classification scheme for CFA image interpolation

(75) Inventors: Zhe Chen, Shanghai (CN); George Chen, Irving, TX (US)

Correspondence Address: STMICROELECTRONICS, INC., MAIL STATION 2346, 1310 ELECTRONICS DRIVE, CARROLLTON, TX, 75006, US

(73) Assignee: STMicroelectroncs, Inc., Carrollton (TX)

(21) Appl. No.: 11/582,128

(22) Filed: Oct. 17, 2006

(30) Foreign Application Priority Data
Oct. 21, 2005 (CN) 200510116542.6

(51) Int. Cl. H04N 9/04

(52) U.S. Cl. 348/273

(57) ABSTRACT

A first image is received and enlarged to create a second image. The second image includes a plurality of unknown pixel values, wherein each unknown pixel value has a plurality of neighboring known pixel values. The unknown pixel values are interpolated from the known pixel values in view of pixel interpolation weights. Interpolation of the unknown pixel values involves determining the needed interpolation weights by: classifying an area of the image into one of a plurality of types based on known pixel values, and obtaining at least one certain interpolation weight based on the classification type of the image area for use in interpolating at least one unknown pixel value.

### PRIORITY CLAIM

This application claims priority from Chinese Application for Patent No. 200510116542.6 filed Oct. 21, 2005 the disclosure of which is hereby incorporated by reference.

### BACKGROUND OF THE INVENTION

1. Technical Field of the Invention

The present invention relates to color filter array (CFA) interpolation and, in particular, to an adaptive classification scheme which assigns weights and/or weight calculation algorithms based on determined image classification type.

2. Description of Related Art

The most frequently used color filter array (CFA) is the Bayer pattern (see, U.S Pat. No. 3,971,065, the disclosure of which is hereby incorporated by reference). This pattern is commonly used in image-enabled devices such as cellular telephones, pocket cameras and other image sensors (such as those used in surveillance applications). Since only a single color component is available at each spatial position (or pixel) of the CFA output, a restored color image, such as an RGB color image, is obtained by interpolating the missing color components from spatially adjacent CFA data. A number of different CFA interpolation methods are well known to those skilled in the art. It is also possible to interpolate a CFA image into a larger sized RGB color image through the processes of CFA image enlargement and interpolation (CFAIEI) which are well known to those skilled in the art.

The interpolation processes known in the art conventionally utilize weighting factors (such as when performing a weighted averaging process) when interpolating an unknown pixel value from a plurality of neighboring known pixel values. The calculation of the weights used in the CFA interpolation process is typically a heavy computation process which takes both significant time and significant power to complete. In small form factor, especially portable, battery powered imaging devices such as cellular telephones or pocket cameras, such computation requirements drain the battery and can significantly shorten the time between battery recharge or replacement. There is accordingly a need in the art to more efficiently calculate weights for use in CFA interpolation processes.

The foregoing may be better understood by reference to prior art exemplary CFA interpolation processes. As discussed in R. Lukac, et al., “Digital Camera Zooming Based on Unified CFA Image Processing Steps,” IEEE Transactions on Consumer Electronics, vol. 50, no. 1, February 2004, pp. 15-24 (see, Equations (4) and (5) on page 16); and R. Lukak, et al., Bayer Patter Demosaicking Using Data-dependent Adaptive Filters,” Proceedings 22^{nd} Biennial Symposium on Communications, Queen's University, May 2004, pp. 207-209 (see, Equation (2) page 207); the disclosures of both of which being incorporated herein by reference, conventional weighting approaches use a computationally complex, single formula set to calculate weights across the entire image area. Execution of this complex formula with respect to each unknown pixel location to calculate the necessary interpolation weights requires a significant number of computations which consume both time and power. There would be an advantage if a more computationally efficient process were available for weight calculation.

It is further recognized by those skilled in the art, that the quality of the interpolated image resulting from the use of such prior art weighting formulae may be acceptable with respect to a certain image type, there is room for improvement. For example, there would be an advantage if the quality of the interpolated image could be improved (both with respect to perceptual quality and PSNR/MAE/NCD quality indices) over the prior art when the image is not particularly smooth, such as where there are edges and lines in the source/input image.

### SUMMARY OF THE INVENTION

In accordance with an embodiment of the present invention, an image interpolation process, wherein the image includes an unknown pixel value surrounded by a plurality of known pixel values, comprises classifying an area of the image where the unknown and known pixels are located into one of a plurality of types, and choosing from a plurality of weight calculation formulae a certain weight calculation formula based on the classification type of the image area. Interpolation weights are then calculated using the chosen certain weight calculation formula, and the unknown pixel value is interpolated from the surrounding known pixel values using the calculated interpolation weights.

In accordance with another embodiment of the present invention, an image interpolation process, wherein the image includes an unknown pixel value surrounded by a plurality of known pixel values, comprises classifying an area of the image where the unknown and known pixels are located into one of a plurality of types, and choosing from a plurality of predetermined interpolation weights at least one certain interpolation weight based on the classification type of the image area. The unknown pixel value is then interpolated from the surrounding known pixel values using the chosen at least one certain interpolation weight.

In accordance with another embodiment, a process comprises receiving a first image, enlarging the first image to create a second image, the second image including a plurality of unknown pixel values, wherein each unknown pixel value has a plurality of neighboring known pixel values, and interpolating the unknown pixel values from the known pixel values in view of pixel interpolation weights. In this context, interpolating includes determining those interpolation weights by: classifying an area of the image into one of a plurality of types based on known pixel values, and obtaining at least one certain interpolation weight based on the classification type of the image area for use in interpolating at least one unknown pixel value.

### BRIEF DESCRIPTION OF THE DRAWINGS

A more complete understanding of the invention may be obtained by reference to the accompanying drawings wherein:

FIG. 1 is a block diagram of an image interpolation device;

FIG. 2 is a block diagram of a CFA image enlargement and interpolation device;

FIG. 3 is a flow diagram showing a pixel interpolation process in accordance with an embodiment of the present invention;

FIG. 4 is a flow diagram illustrating an embodiment of the image type classification process performed in FIG. 3;

FIG. 5 illustrates pixel arrangements for a smooth image area;

FIG. 6 illustrates pixel arrangements for a singular neighbor image area;

FIGS. 7 and 8 illustrate pixel arrangements for line/edge image areas;

FIG. 9 is a more detailed flow diagram of an embodiment of the image type classification process performed in FIGS. 3 and 4;

FIG. 10 is a flow diagram of an embodiment of the weight calculation process performed in FIG. 3; and

FIG. 11 is a flow diagram of another embodiment of the weight calculation process performed in FIG. 3.

### DETAILED DESCRIPTION OF THE DRAWINGS

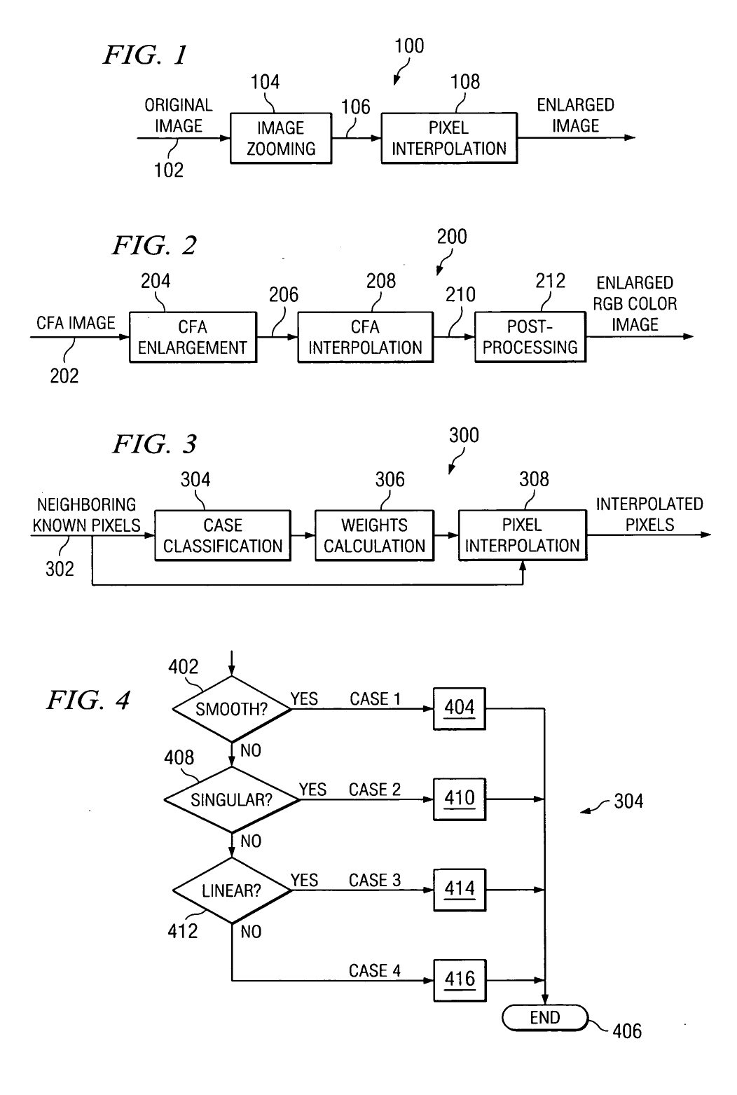

Reference is now made to FIG. 1 wherein there is shown a block diagram of an image interpolation device 100 having processing functionalities which can be implemented in hardware, software or firmware as desired. For example, in a hardware implementation, the device 100 could comprise an application specific integrated circuit (ASIC) whose circuitry is designed to implement certain information processing tasks. Alternatively, in a software implementation, the device 100 could comprise a processor executing an application program for performing those information processing tasks. Design and construction of a physical implementation of the device 100 is well within the capabilities of those skilled in the art.

The device 100 functions to receive 102 an original image. A functionality 104 processes the received original image so as to zoom it into a larger-sized intermediate image 106. As is well known in the art, the process for zooming creates the intermediate image 106 with a number of unknown pixels. Next, a pixel interpolation process is performed by a functionality 108 to figure out and fill in the unknown pixels by using the values of neighboring pixels obtained from the originally received 102 image. As discussed above, prior art interpolation processes typically utilize a single formula for calculating weights across the entire image area. Embodiments of the present invention, however, with respect to the interpolation process performed by functionality 108, utilize an improved process to be discussed in more detail herein whereby the image in the area where interpolation is being performed is classified, and then a) a certain predetermined weight(s) is assigned based on that image classification and/or b) a certain weight formula specified for that image classification is then used to calculate the interpolation weights.

Reference is now made to FIG. 2 wherein there is shown a block diagram of a CFA image enlargement and interpolation (CFAIEI) device 200 having processing functionalities which can be implemented in hardware, software or firmware as desired. For example, in a hardware implementation, the device 200 could comprise an application specific integrated circuit (ASIC) whose circuitry is designed to implement certain information processing tasks. Alternatively, in a software implementation, the device 200 could comprise a processor executing an application program for performing those information processing tasks. Design and construction of a physical implementation of the device 200 is well within the capabilities of those skilled in the art.

The device 200 functions to receive 202 a CFA image. A functionality 204 processes the received CFA image by interpolating the image into a larger-sized CFA image 206. As is well known in the art, the process for CFA image enlargement performed by functionality 204 involves zooming the original CFA image which creates an intermediate image with a number of unknown pixels. The CFA image enlargement performed by functionality 204 also includes a pixel interpolation to figure out and fill in the unknown pixels by using the values of neighboring pixels obtained from the originally received 202 image. Next, a CFA-RGB pixel interpolation process is performed by functionality 208 to convert the larger-sized CFA image 206 into an equal-sized RGB image 210. Lastly, post processing procedures are implemented by functionality 212 to reduce false color artifacts and enhance sharpness of the RGB image 210. These post processing procedures performed by functionality 212 may utilize interpolation processes. As discussed above, prior art interpolation processes such as those used by functionalities 204, 208 and 212 typically utilize a single formula for a given process to calculate weights across the entire image area. Embodiments of the present invention, however, with respect to the interpolation process performed by functionalities 204, 208 and 212, utilize an improved process to be discussed in more detail herein whereby the image in the area where interpolation is being performed is classified, and then a) a certain predetermined weight(s) is assigned based on that image classification and/or b) a certain weight formula specified for that image classification is then used to calculate the interpolation weights.

Reference is now made to FIG. 3 wherein there is shown a flow diagram showing a pixel interpolation process 300 in accordance with an embodiment of the present invention. The process 300 may be used in connection with any pixel interpolation processing functionality including, without limitation, those interpolation procedures used by the functionality 108 of FIG. 1 and functionalities 204, 208 and 212 of FIG. 2.

A image to be interpolated includes a mixture of known pixel values and unknown (i.e., missing) pixel values which are to be interpolated from those known pixel values. As discussed above, this image could comprise a larger-sized intermediate image 106 obtained from zooming a received original image (as with functionality 104 of FIG. 1). Alternatively, this image could comprise an intermediate CFA image obtained by zooming an original CFA image (as with functionality 204 of FIG. 2). Still further, this image could comprise a certain-sized CFA image which is being converted into an equally-sized RGB image (as with functionality 208 of FIG. 2). Alternatively, this image could comprise an RGB image which is being post processed (as with functionality 212 of FIG. 2). In fact, the image to be interpolated could be any type or kind of image known in the art to which a weight-based interpolation process is being performed.

The pixel interpolation process of FIG. 3 comprises the step of receiving 302 known pixel values from a certain area of the image surrounding a certain unknown pixel value to be interpolated. Any selected number of known pixel values from the certain area may be received and evaluated in step 304 to classify image type with respect to that certain area. For example, in one implementation of the process 300, four known pixel values surrounding the certain unknown pixel value are evaluated in step 304. In another implementation, sixteen known pixel values surrounding the certain unknown pixel value are evaluated in step 304. In yet another implementation, the number of known pixel values surrounding the certain unknown pixel value which are evaluated in step 304 may vary depending of which image type classification test is being performed.

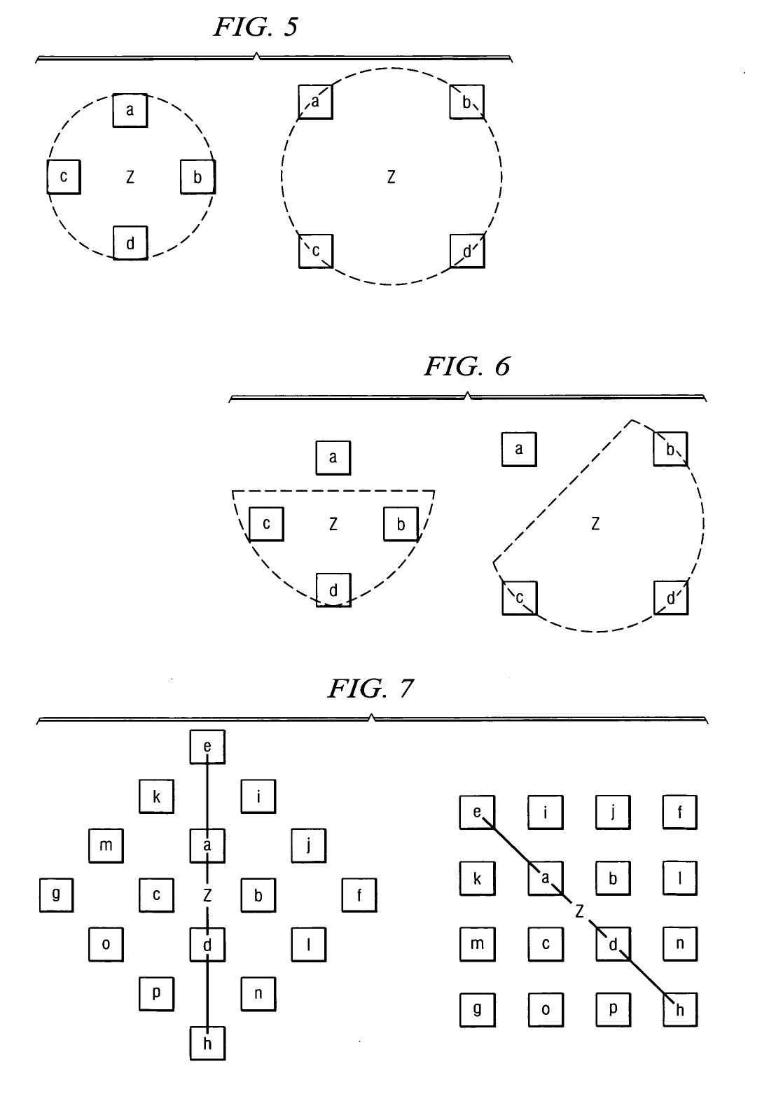

Reference is now made to FIG. 4 wherein there is shown a flow diagram illustrating an embodiment of the image type classification process performed in step 304 of FIG. 3. The image type classification process 304 first checks in step 402 to see if the known pixel values surrounding the certain unknown pixel value are in a smooth area of the first image. By “smooth” it is meant to refer to a smooth region of the image in that the numerical values for an element and its neighbors are very close to each other (i.e., there is little if any variation). This “smooth” class type is illustrated (for both the horizontal/vertical neighbors and diagonal neighbors cases) by the dotted line in FIG. 5 with respect to unknown pixel “z” and known neighboring pixels “a” to “d” where the dotted line encompasses neighbors having similar numerical values. If so (i.e., “YES”), then the certain area of the first image surrounding the certain unknown pixel value to be interpolated is assigned in step 404 an image type classification of “case 1” (i.e., smooth) and the process 304 ends 406 with respect to that particular unknown pixel. As will be discussed in more detail herein, with a case 1 classification type a particular weight(s) can be assigned to the area in subsequent interpolation operations and/or a particular calculation method tailored for smooth areas can be assigned to the area in subsequent interpolation operations. If not (i.e., “NO”), then the process 304 moves on to check in step 408 to see if the known pixel values surrounding the certain unknown pixel value exhibit a singular neighbor. By “singular neighbor” it is meant to refer to a region having an odd neighbor in that the numerical value for one single neighbor is quite different than the numerical values of the other neighbors (which exhibit little variation from each other). This “singular neighbor” class type is illustrated (for both the horizontal/vertical neighbors and diagonal neighbors cases) by the dotted line in FIG. 6 with respect to unknown pixel “z” and known neighboring pixels “a” to “d” where pixel “a” is the singular neighbor whose numerical value is dramatically different than the values of neighbors “b” to “d”. If so (i.e., “YES”), then the certain area of the first image surrounding the certain unknown pixel value to be interpolated is assigned in step 410 an image type classification of “case 2” (i.e., singular neighbor) and the process 304 ends 406 with respect to that pixel. As will be discussed in more detail herein, with a case 2 classification type a particular weight(s) can be assigned to the area in subsequent interpolation operations and/or a particular weight calculation method tailored for areas having singular neighbors can be assigned to the area in subsequent interpolation operations. If not (i.e., “NO”), then the process 304 moves on to check in step 412 to see if the known pixel values surrounding the certain unknown pixel value exhibit an edge or line that covers both some of the neighbors and the unknown pixel location whose value is to be interpolated. If so (i.e., “YES”), then the certain area of the first image surrounding the certain unknown pixel value to be interpolated is assigned in step 414 an image type classification of “case 3” (i.e., line/edge) and the process 304 ends 406 with respect to that pixel. As will be discussed in more detail herein, with a case 3 classification type a particular weight(s) can be assigned to the area in subsequent interpolation operations and/or a particular a weight calculation method tailored for areas having lines or edges can be assigned to the area in subsequent interpolation operations. If not (i.e., “NO”), then the certain area of the first image surrounding the certain unknown pixel value to be interpolated is assigned in step 416 an image type classification of “case 4” (i.e., default or not smooth, singular or line/edge) and the process 304 ends 406 with respect to that pixel. As will be discussed in more detail herein, with a case 4 classification type a particular weight(s) can be assigned to the area in subsequent interpolation operations and/or a particular a weight calculation method tailored for default (or non-type specific) areas can be assigned to the area in subsequent interpolation operations.

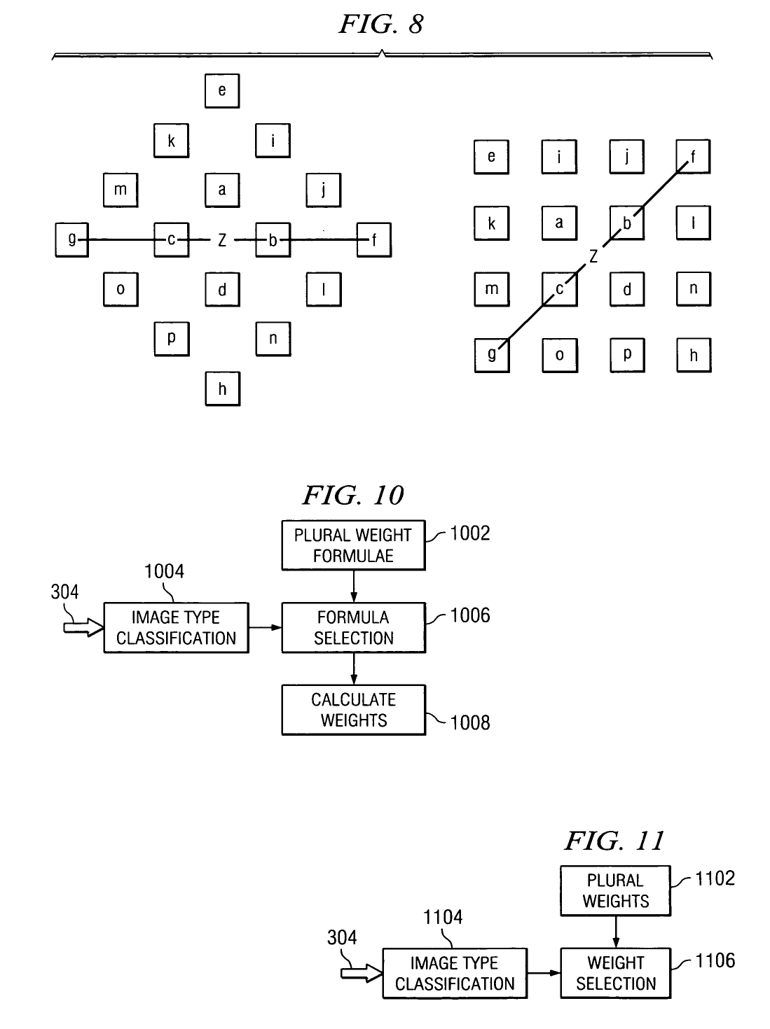

It will be recognized that a line/edge found by the step 412 process could present in any one of a number of orientations. The image type classification of “case 3” (i.e., line/edge) in step 414 could be further refined, if desired, into two or more sub-cases which reflect the orientation direction of the detected line/edge with respect to the known pixel values surrounding the certain unknown pixel value. For example, a first sub-case of this “line/edge” class type with orientation e-h (or a-d) is illustrated (for both the horizontal/vertical neighbors and diagonal neighbors cases) by the lines in FIG. 7 with respect to unknown pixel “z” and known neighboring pixels “a” to “p”. As will be discussed in more detail herein, with a case 3, first sub-case classification type a particular weight(s) can be assigned to the area in subsequent interpolation operations and/or a particular a weight calculation method tailored for areas with e-h (a-d) oriented lines can be assigned to the area in subsequent interpolation operations. A second sub-case of this “line/edge” class type with orientation f-g (or b-c) is illustrated (for both the horizontal/vertical neighbors and diagonal neighbors cases) by the lines in FIG. 8 with respect to unknown pixel “z” and known neighboring pixels “a” to “p”. As will be discussed in more detail herein, with a case 3, second sub-case classification type a particular weight(s) can be assigned to the area in subsequent interpolation operations and/or a particular a weight calculation method tailored for areas with f-g (b-c) oriented lines can be assigned to the area in subsequent interpolation operations.

Reference is now once again made to FIG. 3. The pixel interpolation process of FIG. 3 further comprises the step of calculating interpolation weights in step 306. As discussed above, several known prior art interpolation processes use just a single weight formula in calculating interpolation weights. In accordance with an embodiment of the present invention, step 306 is capable of executing any one of a plurality of predetermined weight formulae based on the case image type classification determination made in step 304. Each available weight formula may be designed specifically for weight calculation in the context of an image area of a certain type (or case). The specific design process for the formulae can take into account not only the type of image area at issue, but also the processing needs, requirements or limitations which are pertinent to the interpolation process. In this way, instead of relying on a single formula that must accommodate different image area types (cases), the formulae (or weight calculation methods) made available in step 306 for selection and execution can be tailored to the specific interpolation needs of the various image area types (cases). The output of the step 306 process is a set of tailored formula (or method) calculated interpolation weights.

In an alternative implementation, the step of calculating interpolation weights in step 306 merely comprises the assigning of weight(s) based on the case image type classification determination made in step 304. Each assigned weight may be designed specifically to support interpolation in the context of an image area of a certain type (or case). The implementation of this embodiment is advantageous in that it obviates the need to execute any weight calculation formulae in real time. Instead, the weight calculation formulae can be pre-executed and the resulting weights loaded in a memory (perhaps in a look-up table format) to be accessed in accordance with the determination of an image area of a certain type (or case) in step 304.

The pixel interpolation process of FIG. 3 still further comprises the step of performing weighted pixel interpolation 308 with respect to the unknown pixel value. In other words, the assigned weight(s) and/or the set of tailored formula calculated interpolation weight(s) output from step 306 are used in any selected weighted interpolation process to calculate the value of the unknown pixel location. More specifically, the assigned weight(s) and/or the set of tailored formula calculated interpolation weight(s) output from step 306 are mathematically applied to the known pixel values from the certain area of the first image surrounding the certain unknown pixel value to calculate the value of the unknown pixel location.

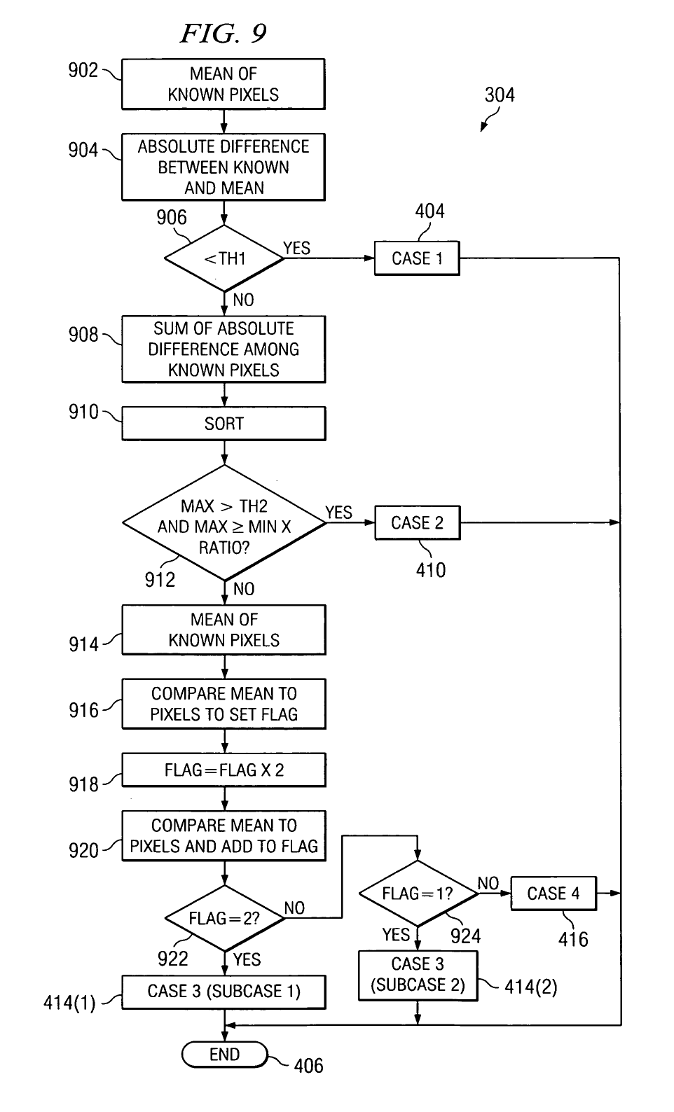

Reference is now made to FIG. 9 wherein there is shown a more detailed flow diagram of an embodiment of the image type classification process performed in step 304 of FIG. 3. For purposes of FIG. 9 and the discussion below, it is noted that all operand and operations are in integer.

In step 902, the mean value M1 of the four known neighboring pixels “a”-“d” is calculated:
M1=(a+b+c+d)>>2,
wherein “=” refers to value assignment and “>>” refers to a right shift. Next, in step 904, the sum of absolute difference between the four known neighboring pixels and the mean M1 is calculated:
SUM=|a−M1|+|b−M1|+|c−M1|+|d−M1|.
Next, in step 906, a decision is made:
SUM<TH1,
wherein TH1 is a preset threshold and “<” is a less-than operation decision. If “YES”, then the known pixel values surrounding the certain unknown pixel value are in a smooth area of the image and the certain area of the image surrounding the certain unknown pixel value to be interpolated is assigned in step 404 an image type classification of “case 1” (i.e., smooth) and the process ends 406 with respect to that pixel. If “NO”, the process moves on to consider a next possible classification case.

The process of steps 902-906 is one particular example of a process for evaluating known neighboring pixels in an effort to determine whether those pixels are located within a smooth area of the image. It will be understood that other algorithms and processes may be used to evaluate known neighboring pixels for this purpose.

In step 908, four sums of absolute difference among the four known pixel values are calculated:
Diff(0)=|a−b|+|a−c|+|a−d|,
Diff(1)=|b−a|+|b−c|+|b−d|,
Diff(2)=|c−a|+|c−b|+|c−d|, and
Diff(3)=|d−a|+|d−b|+|d−c|.
Next, in step 910, the values of Diff(0), . . . , Diff(3) are sorted from smallest to largest an assigned to SDiff(0), . . . , SDiff(3). Thus, after sortation, SDiff(0) contains the smallest value of Diff(0), . . . , Diff(3) and SDiff(3) contains the largest value of Diff(0), . . . , Diff(3). Next, in step 912, a multi-part decision is made. A first part of the decision tests whether:
SDiff(3)−SDiff(2)>TH2,
wherein TH2 is a preset threshold and “>” is a greater-than operation decision, and wherein MAX as shown in FIG. 9 is SDiff(3)−SDiff(2) or the difference between the biggest and second biggest among Diff(0) to Diff(3). A second part of the decision tests whether:
SDiff(3)−SDiff(2)≧(SDiff(2)−SDiff(0))×RATIO,
wherein RATIO is a preset multiplication factor and “≧” is a greater-than-or-equal operation decision, and wherein MAX as shown in FIG. 9 is the same as above, and wherein MIN as shown in FIG. 9 is SDiff(2)−SDiff(0) or the difference between the second biggest and the smallest among Diff(0) to Diff(3). If both parts of the test are “YES”, then one of the known pixel values surrounding the certain unknown pixel value is a singular neighbor and the certain area of the image surrounding the certain unknown pixel value to be interpolated is assigned in step 410 an image type classification of “case 2” (i.e., singular neighbor) and the process ends 406 with respect to that pixel. If either or both parts of the test are “NO”, the process moves on to consider a next possible classification case.

The process of steps 908-912 is one particular example of a process for evaluating known neighboring pixels in an effort to determine whether those pixels are located within an area of the image possessing a singular neighbor. It will be understood that other algorithms and processes may be used to evaluate known neighboring pixels for this purpose.

In step 914, the mean value M2 of the sixteen known neighboring pixels “a”-“p” is calculated:
M2=(a+b+c+d+ . . . m+n+o+p)>>4,
wherein “=” refers to value assignment and “>>” refers to a right shift. Next, in step 916, a logical expression comparing the known pixels to the mean M2 evaluated:
((e>M2) and (a>M2) and (d>M2) and (h>M2)) OR
   ((e<M2) and (a<M2) and (d<M2) and (h<M2))
      If the logical expression evaluated in step 916 is found to be true, then Flag=1, and otherwise Flag=0. Next, in step 918, Flag is multiplied by 2. Since Flag is an integer, left shifting can be used for this operation:
      Flag=Flag<<1,
      wherein “<<” refers to a left shift. Next, in step 920, another logical expression comparing the known pixels to the mean M2 evaluated:
((g>M2) and (c>M2) and (b>M2) and (f>M2)) OR
   ((g<M2) and (c<M2) and (b<M2) and (f<M2))
      If the logical expression evaluated in step 920 is found to be true, then Flag is incremented by 1:
      Flag=Flag+1.
      Otherwise, Flag remains the same.

Next, in step 922, a decision is made as to whether Flag is equal to 2. If “YES”, then the known pixel values surrounding the certain unknown pixel value are in an area of the image where a line or edge is present and the certain area of the image surrounding the certain unknown pixel value to be interpolated is assigned in step 414(1) an image type classification of “case 3” (i.e., linear or line/edge), and “subcase 1” (with an e-h orientation), and the process ends 406 with respect to that pixel. If “NO”, the process moves on to consider a next possible classification case in step 924 where a decision is made as to whether Flag is equal to 1. If “YES”, then the known pixel values surrounding the certain unknown pixel value are in an area of the image where a line or edge is present and the certain area of the image surrounding the certain unknown pixel value to be interpolated is assigned in step 414(2) an image type classification of “case 3” (i.e., linear), and “subcase 2” (with an f-g orientation), and the process ends 406 with respect to that pixel. If “NO”, then the known pixel values surrounding the certain unknown pixel value are in an unclassified area of the image and the certain area of the image surrounding the certain unknown pixel value to be interpolated is assigned in step 416 an image type classification of “case 4” (i.e., default), and the process ends 406.

The process of steps 914-924 is one particular example of a process for evaluating known neighboring pixels in an effort to determine whether those pixels are located within an area of the image possessing a line or edge, and well as determine an orientation of that line or edge. It will be understood that other algorithms and processes may be used to evaluate known neighboring pixels for this purpose.

Reference is now made to FIG. 10 wherein there is shown a flow diagram of an embodiment of the weight calculation process performed in step 306 of FIG. 3. Plural weight calculation formulae are provided in step 1002. In an exemplary embodiment, the number of weight calculation formulae provided correspond with the number of cases (including sub-cases) that are identifiable by the image type classification process performed in step 304 of FIG. 3. The step 304 assigned image type classification (case/sub-case) for the image area of the known neighboring pixels is received at step 1004. In step 1006, a formula selection process is implemented to select a certain one of the plural weight formulae (provided in step 1002). This selection is made in step 1006 in one embodiment by providing through step 1002 one weight calculation formula tailored for each possible step 304 assigned image type classification (case/sub-case). In step 1006, formula selection is simply made by choosing the step 1002 provided formula which corresponds to the step 304 determined image type classification.

As a example, taken in the context of the exemplary implementation for determining image type classification shown in FIG. 9, step 1002 provides a weight formula for each of the smooth, singular neighbor, linear (sub-case 1), linear (sub-case 2) and default image type classifications. Formula selection in step 1006 simply operates to select the one of those formulae which match the image type classifications determined in step 304. As examples, any suitable arithmetic averaging formula may be selected and made available in step 1002 for a smooth classification, a singular neighbor classification, and a default classification, while any suitable cubic filter formula may be selected and made available in step 1002 for a linear (sub-case 1 or sub-case 2) classification. Arithmetic averaging and cubic filtering algorithms are well known in the art, and provision of appropriate formulae for this application in step 1002 is well within the capabilities of one skilled in the art.

After having made a formula selection, the process of FIG. 10 continues to step 1008 where the selected formula is used to calculate the necessary interpolation weights. The calculated weights are output to the step 308 process of FIG. 3 where the weights are used in interpolating the unknown pixel value from the surrounding known pixel values.

Reference is now made to FIG. 11 wherein there is shown a flow diagram of another embodiment of the weight calculation process performed in FIG. 3. Plural assigned weights are provided in step 1102. In an exemplary embodiment, the weights provided correspond with the cases (including sub-cases) that are identifiable by the image type classification process performed in step 304 of FIG. 3. The step 304 assigned image type classification (case/sub-case) for the image area of the known neighboring pixels is received at step 1104. In step 1106, a weight selection process is implemented to select certain one(s) of the weights (provided in step 1102). This selection is made in step 1106 in this embodiment by providing through step 1102 one or more specific weights (which are pre-determined) and tailored for each possible step 304 assigned image type classification (case/sub-case). In step 1106, weight selection is simply made by choosing the step 1102 provided weight(s) which corresponds to the step 304 determined image type classification. The selected weights are output to the step 308 process of FIG. 3 where the weights are used in interpolating the unknown pixel value from the surrounding known pixel values.

As a example, taken in the context of the exemplary implementation for determining image type classification shown in FIG. 9, step 1102 provides weights for each of the smooth, singular neighbor, linear (sub-case 1), linear (sub-case 2) and default image type classifications. Weight selection in step 1106 simply operates to select the one(s) of those weights which match the image type classifications determined in step 304. As an example, consider Wₓ to be weight coefficient for the element x, where x is a neighbor of the element z that is to be interpolated. In this context, the element z can be interpolated in step 308 (FIG. 3) by:

$$z = {\sum }_{{x}_{i}} {W}_{{x}_{i}} \cdot {x}_{i}$$

For the smooth classification case, the weights made available in step 1102 for selection in step 1106, given four neighbors “a” to “d” as shown in FIG. 5 may be Wₐ=W_{b}=W_{c}=W_{d}=¼. For the singular neighbor classification case, the weights made available in step 1102 for selection in step 1106, given four neighbors “a” to “d” as shown in FIG. 6 may be Wₐ=0, and W_{b}=W_{c}=W_{d}=⅓.
For linear (sub-case 1) classification, the weights made available in step 1102 for selection in step 1106, given sixteen neighbors “a” to “p” as shown in FIG. 7 may be W_{b}=W_{d}= 9/16 and Wₑ=Wₕ=− 1/16 for the neighbors along the line.
For linear (sub-case 2) classification, the weights made available in step 1102 for selection in step 1106, given sixteen neighbors “a” to “p” as shown in FIG. 7 may be W_{b}=W_{c}= 9/16 and W_{f}=W_{g}=− 1/16 for the neighbors along the line.
For the default classification, the weights made available in step 1102 for selection in step 1106, given four neighbors “a” to “d” may be Wₐ=W_{b}=W_{c}=W_{d}=¼. It will be noted that this default condition is the same as for the smooth classification. This is simply a matter of choice, and the weights could instead have other values as desired.

It will be recognized that the operations disclosed herein differ from the identified prior art processes in that prior solutions do not distinguish any cases or classifications with respect to the image being processed before interpolation weights are selected and/or calculated. Thus, the prior art solutions use only one complex formula for interpolation weight calculation. The solution proposed herein, on the contrary, classifies the image into one of at least four cases before the interpolation weights are selected and/or calculated. This enables a diverse set of weight calculation formulae to be made available, and for a selection to be made as to a certain one of the available formulae which is best suited or tailored to the determined image classification. Alternatively, this enables predetermined weights to be made available, and for a selection to be made as to certain weights which are best suited or tailored to the determined image classification. By introducing this adaptive classification approach to interpolation, and in particular to the calculation and/or selection of interpolation weights, a number of benefits accrue including: a) the quality of resulting images is improved in perception, especially where there are regular edges in original images; and b) the total computation requirement (time, cycles, power, etc.) for weight calculation/selection is greatly reduced.

Operation of the solution presented here has been compared with operation of the prior art solution (as taught by the Lukac, et al. articles cited above) using the embodiment described above (and illustrated in connection with FIG. 11) wherein the weights are predetermined for several different classifications. In image quality tests, side by side perception comparison reveals that the resulting images from the prior art solution and the present solution are quite similar. Peak-to-signal ration (PSNR) is used to compare noise suppression, and the PSNR values for the present solution are nearly the same as with the prior art solution. Mean absolute error (MAE) is used to evaluate edge and fine detail preservation with the resulting images, and the MAE values for the present solution are nearly the same as with the prior art solution. Normalized color difference (NCD) is used to estimate perceptual error, and the NCD values for the present solution are nearly the same as with the prior art solution. With respect to computation comparisons, the prior art solution and the present solution were implemented on a digital signal processor (DSP) and the number of cycles required for classification and weight calculation for a pixel (color element) were counted. A significantly reduced number of computation cycles were needed for the present solution (81 cycles) in comparison to the prior art solution (1,681 cycles). This reduction can be primarily attributed to the fact that weight calculation formulae (or algorithms) need not be executed in real time since the weights for each image classification case had been pre-calculated and predetermined.

The foregoing shows that the approach of the present solution performs comparable or better that the prior art solution in terms of the quality of the resulting images. The most important advantage of the present solution is that the total computational requirement in weight calculation is greatly reduced in comparison to the prior art solution. In fact, some experimentation shows that the computation requirement for the present solution, when using predetermined weights, is reduced down to about 5% of that required for the prior art solution. Reductions in computation requirements can also be achieved, even when using weight calculation formulae executed in real time, if some predetermined weights are made available and/or if the formulae which are executed have been designed with a reduced computation requirement.

Although preferred embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. An image interpolation process, wherein the image includes an unknown pixel value surrounded by a plurality of known pixel values, comprising:
classifying an area of the image where the unknown and known pixels are located into one of a plurality of types;
choosing from a plurality of weight calculation formulae a certain weight calculation formula based on the classification type of the image area;
calculating interpolation weights using the chosen certain weight calculation formula; and
interpolating the unknown pixel value from the surrounding known pixel values using the calculated interpolation weights.

2. The process of claim 1 wherein the plurality of classification types include smooth region, singular neighbor and linear.

3. The process of claim 2 wherein the linear classification type includes plural sub-cases dependent on line orientation with respect to the known pixels.

4. The process of claim 2 wherein in the smooth region classification type the known pixels have similar pixel values.

5. The process of claim 2 wherein in the singular neighbor classification type the known pixels include a single known pixel having a pixel value that is substantially different than the pixel values of the other known pixels.

6. The process of claim 2 wherein the linear classification type the known pixels have values indicative of the presence of a line or edge passing through the image area.

7. The process of claim 1 wherein the recited steps are performed by an integrated circuit device.

8. An image interpolation process, wherein the image includes an unknown pixel value surrounded by a plurality of known pixel values, comprising:
classifying an area of the image where the unknown and known pixels are located into one of a plurality of types;
choosing from a plurality of predetermined interpolation weights at least one certain interpolation weight based on the classification type of the image area; and
interpolating the unknown pixel value from the surrounding known pixel values using the chosen at least one certain interpolation weight.

9. The process of claim 8 wherein the plurality of classification types include smooth region, singular neighbor and linear.

10. The process of claim 9 wherein the linear classification type includes plural sub-cases dependent on line orientation with respect to the known pixels.

11. The process of claim 9 wherein in the smooth region classification type the known pixels have similar pixel values.

12. The process of claim 9 wherein in the singular neighbor classification type the known pixels include a single known pixel having a pixel value that is substantially different than the pixel values of the other known pixels.

13. The process of claim 9 wherein the linear classification type the known pixels have values indicative of the presence of a line or edge passing through the image area.

14. The process of claim 8 wherein the recited steps are performed by an integrated circuit device.

15. A process, comprising:
receiving a first image;
enlarging the first image to create a second image, the second image including a plurality of unknown pixel values, wherein each unknown pixel value has a plurality of neighboring known pixel values; and
interpolating the unknown pixel values from the known pixel values in view of pixel interpolation weights, wherein interpolating includes determining those interpolation weights and wherein determining comprises:
classifying an area of the image into one of a plurality of types based on known pixel values; and
obtaining at least one certain interpolation weight based on the classification type of the image area for use in interpolating at least one unknown pixel value.

16. The process of claim 15 wherein the first image is a CFA image, the second image is an enlarged CFA image and interpolating generates an RGB image.

17. The process of claim 15 wherein obtaining comprises:
choosing from a plurality of weight calculation formulae a certain weight calculation formula based on the classification type of the image area;
calculating the at least one certain interpolation weight using the chosen certain weight calculation formula.

18. The process of claim 15 wherein obtaining comprises choosing from a plurality of predetermined interpolation weights the at least one certain interpolation weight based on the classification type of the image area.

19. The process of claim 15 wherein the plurality of classification types include smooth region, singular neighbor and linear.

20. The process of claim 19 wherein the linear classification type includes plural sub-cases dependent on line orientation with respect to the known pixels.

21. The process of claim 19 wherein in the smooth region classification type the known pixels have similar pixel values.

22. The process of claim 19 wherein in the singular neighbor classification type the known pixels include a single known pixel having a pixel value that is substantially different than the pixel values of the other known pixels.

23. The process of claim 19 wherein the linear classification type the known pixels have values indicative of the presence of a line or edge passing through the image area.

24. The process of claim 15 wherein the recited steps are performed by an integrated circuit device.
